(19) United States
(12) Patent Application Publication
(10) Pub. No.: US 2013/0048028 A1
(43) Pub. Date: Feb. 28, 2013

(54) Water Heater Rejuvenation System and Process

(71) Applicant: Kevin J. Morin, Kalispell, MT (US)

(72) Inventor: Kevin J. Morin, Kalispell, MT (US)

(21) Appl. No.: 13/220,573

(22) Filed: Aug. 29, 2011

(51) Int. Cl. B08B 9/08

(52) U.S. Cl. 134/22.1; 134/166 R

(57) ABSTRACT

A water heater rejuvenation system and process wherein a system kit comprises an introduction-extraction tube, a water heater wrench, and an amount of calcium cleaning solution. The system and process may include the steps of draining the water heater reservoir, opening an access to the water heater reservoir, introducing an amount of calcium cleaning solution into the reservoir, via an introduction-extraction tube, allowing an amount of time to pass, extracting the cleaning solution and debris from the reservoir with the introduction-extraction tube, closing the access to the reservoir, and filling the reservoir with water. Alternatively, the system and process may include introducing an additional amount of solution to remove additional debris, and using a wet/dry vacuum to facilitate extraction of the solution and debris from the reservoir.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Tank water heaters are known to lose effectiveness and have shortened operational life due to a buildup of material in the reservoir that typically comes out of the water while the water is in the water heater reservoir. The current system, and process, and the exemplar kit help alleviate the problem, thereby extending the life of the water heater.

### BRIEF DESCRIPTION OF THE DRAWINGS

The invention will be explained in conjunction with an illustrative embodiment shown in the accompanying drawings, in which;

FIG. 1 is a perspective illustration of an exemplary embodiment of the current invention, along with an exemplary workpiece water heater and an exemplary suitable vacuum source;

FIG. 2 is a process flow diagram of an embodiment of the current invention; and

FIGS. 3 through 7 are a perspective schematic illustration of an exemplary embodiment being used to perform an exemplary process on an exemplary workpiece water heater and an exemplary suitable vacuum source, where the exterior of the water heater is selectively removed in FIGS. 3, 6, and 7.

### DESCRIPTION OF THE ILLUSTRATED EMBODIMENT

The current system and process allows users to easily, effectively, and conveniently cleanse and remove debris, which may include calcium and mineral deposits, from a water heating system, prolonging the life of the water heater. This cleaning system uses a cleaning solution, along with a durable hose and a suitable vacuum source, such as wet/dry vacuum, to remove buildup that can accumulate over time in water heaters. The cleaning solution loosens and breaks-down the debris weakening their bond to the water heater. The hose and wet/dry vacuum can then be used to introduce the cleaning solution into the reservoir, and then suck out the debris, allowing the water heater to heat more efficiently, extending the life of the water heater.

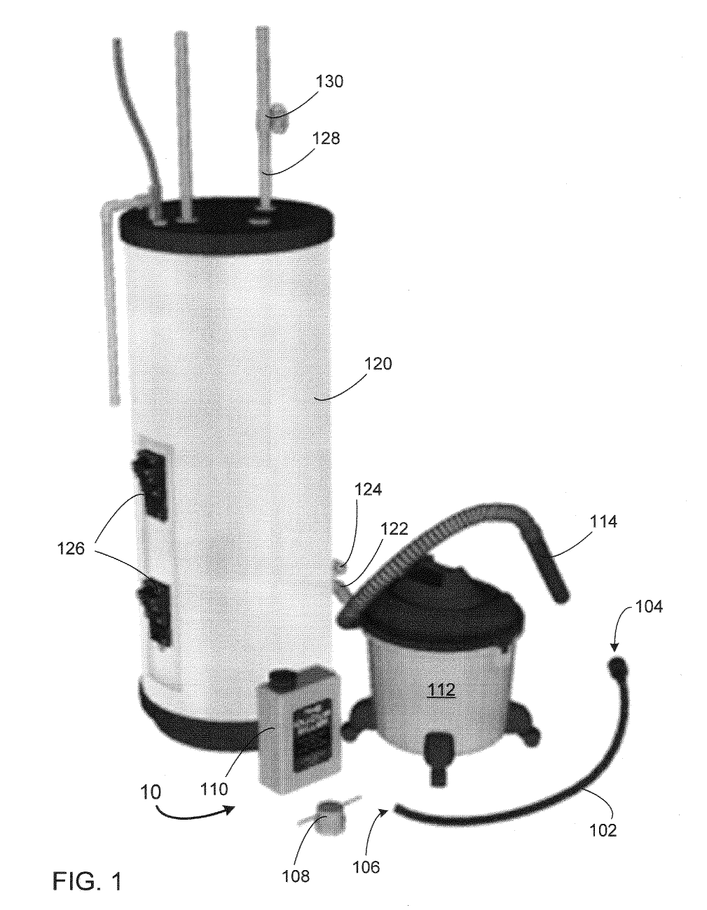

Now, referring to FIG. 1, the exemplary embodiment of equipment useful to accomplish the current process is shown with other general equipment helpful in practicing the device and process. An exemplary water heater cleaning kit 10 may comprise an exemplary introduction-extraction conduit 102, an exemplary water heater wrench 108, and an exemplary volume of cleaning solution 110. The conduit 102 may be formed by a suitable conduit, such as a tube, hose, and pipe, and may be somewhat flexible, though a rigid conduit material may be appropriately adapted to serve as a suitable conduit 102. Additionally, the conduit 102 should be of a suitable diameter to be insertable into an orifice in a water heater tank 200, as will be described below. The exemplary conduit 102 has an adapter end 104, suitably formed to be able to serve as a funnel and removably, sealably attach to at vacuum hose 114 of a suitable vacuum generator 112, such as a wet/dry vacuum. The exemplary conduit 102 also has an insertion end 106, in fluid communication with, and distal to, the adapter end 104.

The exemplary water heater wrench 108 is a suitable tool for opening an orifice in a water heater tank 120, as will be described below. The exemplary cleaning solution 110 is an adequate volume of solution to cover the entire bottom of the particular water tank 120 to be cleaned with a depth adequate to effectively loosen and dislodge the quantity of debris in the particular water tank 120, in some eases the entire bottom of the water tank 120 to be cleaned is less than the footprint area of the water heater, since the interior of the water tank may have a convex bottom. Exemplary solutions 110 may include various liquids known or understood to dissolve or loosen the debris in the tank 120. Typically, calcium is a substantial component of the debris, and suitable liquids may include a variety of acidic liquids, such as muriatic and phosphoric acid, but may also include a suitable commercially available product, such CLR®. Additionally suitable liquids may also include naturally acidic substances, such as fruit, such as apple, orange, lemon, or lime juice, and vegetable juices, such as tomato. In addition to the liquids, suitable density enhancing agent that may be dissolved or suspended in one or more of the various liquids may be included in the solution 110. Magnesium sulfate, magnesium chloride, sodium chloride, sodium sulfate, potassium sulfate, and potassium chloride are examples of solid material that may be suitably added to the liquid to increase the effectiveness of the cleaning process. An exemplary suitable solution may be made from a cup of citrus juice, e.g., lime juice, a tablespoon of magnesium chloride, e.g., Epson salts, and a quantity of water to make a combined volume of about sixty-four ounces or about two liters.

Also shown in FIG. 1 is a typical water heater 120 rejuvenatable with the current apparatus, process, and kit. The heater tank 120 typically has a drain 122 that has a drain valve 124 operatable to open and close the drain 122, so that any water contained with the interior reservoir may be substantially drained from the water tank 120. Additionally, on an electric model water heater 120, at least one heating element assembly 126 is accessible from the outside of the water tank 120. Additionally, the water tank 120 may have a water inlet 128, which may have an inlet valve 130 operatable to permit and inhibit the flow of water through the water inlet 128.

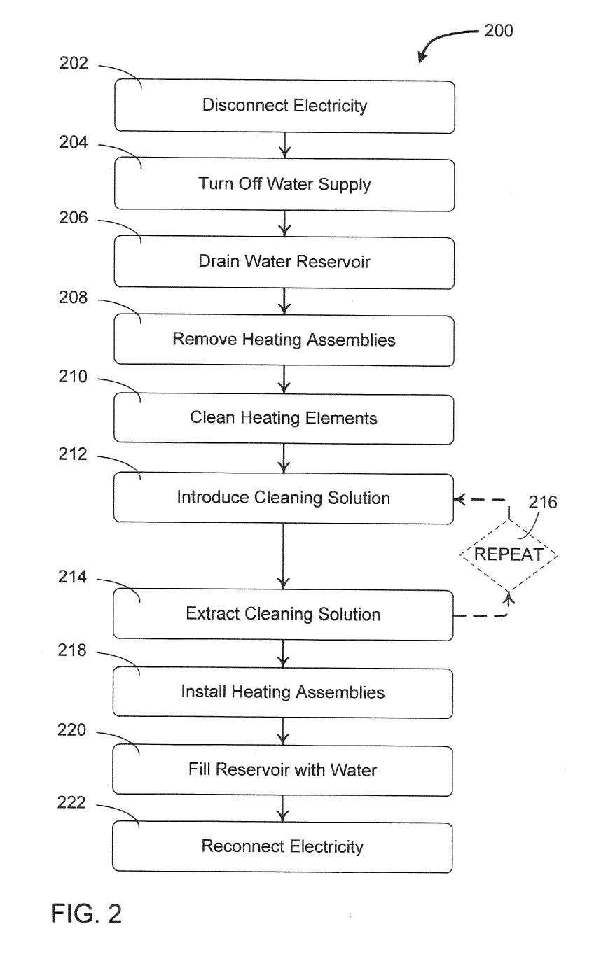

Referring now to FIG. 2, an exemplary water heater rejuvenation process 200 is show by steps. The process may comprise of the following exemplary steps, but the limitation of the invention is delineated by the actual claims. Addition steps may be included in the example that are prudent in practice, but may not be essential to the invention as limited by the actual claims.

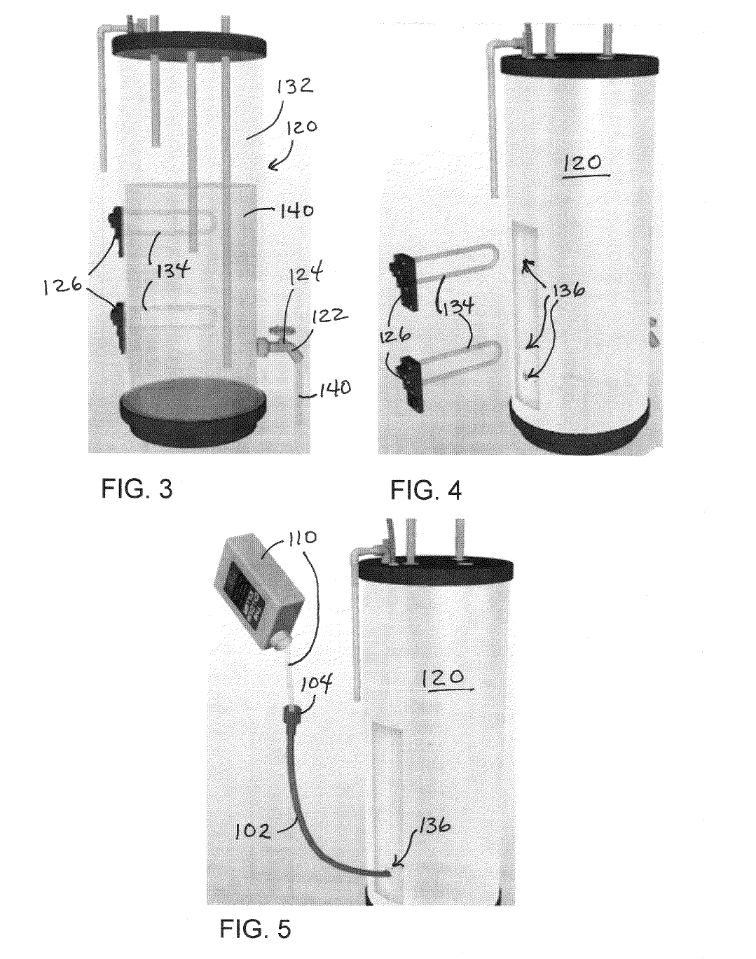

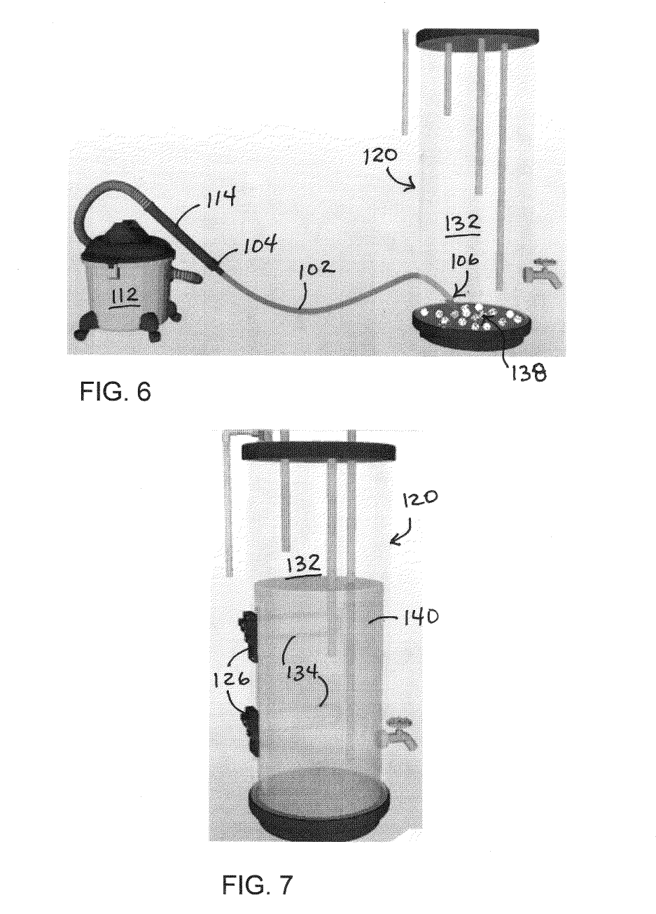

Referring, also now to FIGS. 3 through 7, the exemplary process may include step 202 of disconnecting the electricity, so as to eliminate the hazard of being electrocuted, and step 204 turning off the water supply. Turning off the water supply step 204 may be accomplished by operating inlet valve 130, so that a water supply is interrupted from water inlet 128, preventing the introduction of additional water supply into the reservoir 132 in tank 120. Though steps 202 and 204 are shown as sequential, the actual order in which they are performed is not necessarily important to the general process.

Next, in step 206, one may drain the water reservoir 132 to expose the debris in the reservoir 132, as shown in FIG. 3, and permit step 208, removing the heating assembly 126, as shown in FIG. 4. Draining step 206 may be accomplished by opening drain valve 124, and permitting water 140 contained within reservoir 132 of tank 120, to flow from drain 122. Removing step 208 may be accomplished by employing water heater wrench 108 to loosen and remove the heating assembly 126. Removing heating assembly 126 removes the heating elements 134 from the interior of reservoir 132, and provides access to one or more reservoir openings 136.

Once heating, assembly 126 is removed heating elements 138 are exposed, and in step 210 one may be cleaned by rinsing or soaking the elements with solution 110 in a suitable container, such as a bucket (not shown). Heating elements 134 may be delicate, so care should be taken to not damage the elements with adverse sharp or abrupt contact, such as scraping or chipping at any debris that may be deposited. The cleaning solution 110 should be allowed to loosen the debris from the element 134. Agitation of the solution 110 may assist in removal of the debris.

Now that the reservoir openings 136 are accessible, step 212, introducing the cleaning solution 110 into the reservoir 132, may be performed. The cleaning solution 110 may be introduced to the interior of the reservoir through the exemplary conduit 102. Insertion end 106 is inserted into the reservoir 132 through opening 136. Solution 110 may be poured into adapter end 104, and communicated through conduit 102 into the bottom of reservoir 132, as shown in FIG. 5.

At step 212, the cleaning solution may be allowed time to be exposed to the debris in order to facilitate thorough loosening and cleaning, after which step 214, extracting the cleaning solution 110 is performed. The extracting step 214 may be accomplished by attaching a suitable vacuum source 112 to the conduit 102. Attachment end 104 may be constructed to provide a suitable vacuum seal with vacuum hose 114. In the exemplary embodiment, a wet/dry vacuum 112 extracts solution 110 and debris 138 from the bottom of reservoir 132. It may be advisable to perform step 216, and repeat introduction step 212 and extraction step 214 at least one time, or until a suitable quantity of debris 138 is removed or cleanliness is achieved.

With introduction step 212 and extraction step 214 suitably completed, the water heater 120 may be placed back into a state ready for operation. In step 218, installing the heating assembly 126, the heating elements 134 are reinserted into the interior of the reservoir 132 through openings 136. Water heater wrench 108 is used to secure heating assemblies 126 in the tank 120.

Once the openings 136 are closed by the securely seated heating assemblies 126, step 220, tiling the reservoir with water, and step 222 reconnecting the electricity, may be performed to restore the water heating system to standard operation without the burden of the damaging debris.

In an alternate exemplary embodiment (not shown), the first step may be taking the water heater out of operation. This step would include alternate steps taken to prepare the exemplary water heater 120 or alternate embodiments, such as a gas energized water heater (not shown), for the rejuvenation process. In an alternate gas embodiment, the energy supply, or gas line, may need to be interrupted, as with a gas line valve. The other steps of the process could potentially remain similar, adjusted to consider the modifications of the alternate embodiment water heater.

In an alternate exemplary embodiment, water heater wrench may be a wrench adapted to open on orifice in the reservoir of a particular model water heater, if the heater assembly is not removable. Suitable orifices may include the drain hole, the pressure relief hole, or an alternate hole available in the particular model water heater. The kit to perform the current rejuvenation process would then provide for a particularly suited water heater wrench to accomplish a step of removing a closure element from an opening in the reservoir, as well as a step of closing the reservoir opening.

In an alternate exemplary embodiment, the final step may be placing the water heater 120 back into operation. This step would include alternate steps taken to prepare the exemplary water heater 120 or alternate embodiments, such as a gas energized water heater to resume water heating operation. In an alternate gas embodiment, the energy supply, or gas line, may need to be reestablished, as with a gas line valve, which should include reigniting a pilot light, as appropriate.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A process for rejuvenating a water heater having a reservoir, comprising:
taking the water heater out of operation;
removing a closure element from an opening in the reservoir;
introducing a quantity of cleaning solution into the reservoir through the opening;
extracting the cleaning solution and a quantity of debris from the reservoir;
closing the reservoir opening; and
placing the water heater back into operation.

2. The process of claim 1 wherein taking the water heater out of operation comprises the steps of:
interrupting an energy supply, turning off a water supply, and draining the reservoir.

3. The process of claim 1 wherein placing the water heater back into operation comprises the steps of:
reestablishing an energy supply, turning on a water supply, and filling the reservoir.

4. The process of claim 1 wherein the cleaning solution comprises one or more suitable cleaning substances chosen from the group of muriatic acid, phosphoric acid, CLR®, vinegar, fruit juice, and vegetable juice.

5. The process of claim 1 wherein the cleaning solution comprises one or more citrus fruit juices.

6. The process of claim 1 wherein the cleaning solution comprises one or more citrus fruit juices, and a density enhancing agent.

7. The process of claim 6 wherein the density enhancing agent comprises one or more suitable substances chosen from the group of magnesium sulfate, magnesium chloride, sodium chloride, sodium sulfate, potassium sulfate, and potassium chloride.

8. A process for rejuvenating a water heater having a reservoir, comprising:
taking the water heater out of operation;
removing a heating element from an opening in the reservoir;
introducing a quantity of cleaning solution into the reservoir through the opening;
extracting the cleaning solution and a quantity of debris from the reservoir;
replacing the heating element securely in the reservoir opening; and
placing the water heater back into operation.

9. The process of claim 8 wherein taking the water heater out of operation comprises the steps of:
disconnecting an electrical supply, turning off a water supply, and draining the reservoir.

10. The process of claim 8 wherein placing the water heater back into operation comprises the steps of:
connecting an electrical supply, turning on a water supply, and filling the reservoir.

11. The process of claim 8 wherein the cleaning solution comprises one or more suitable cleaning substances chosen from the group of muriatic acid, phosphoric acid, CLR®, vinegar, fruit juice, and vegetable juice.

12. The process of claim 8 wherein the cleaning solution comprises one or more citrus fruit juices.

13. The process of claim 8 wherein the cleaning solution comprises one or more citrus fruit juices, and a density enhancing agent.

14. The process of claim 13 wherein the density enhancing agent comprises one or more suitable substances chosen from the group of magnesium sulfate, magnesium chloride, sodium chloride, sodium sulfate, potassium sulfate, and potassium chloride.

15. A kit for performing a rejuvenation process on a water heater, comprising:
a quantity of cleaning solution, a water heater wrench, and an insertion/extraction conduit.

16. The kit of claim 15 wherein the cleaning solution comprises one or more suitable cleaning substances chosen from the group of muriatic acid, phosphoric acid, CLR®, vinegar, fruit juice, and vegetable juice.

17. The kit of claim 15 wherein the cleaning solution comprises one or more citrus fruit juices.

18. The kit of claim 15 wherein the cleaning solution comprises one or more citrus fruit juices, and a density enhancing agent.

19. The kit of claim 18 wherein the density enhancing agent comprises one or more suitable substances chosen front the group of magnesium sulfate, magnesium chloride, sodium chloride, sodium sulfate, potassium sulfate, and potassium chloride.

20. The kit of claim 15 wherein the cleaning solution comprises lime juices, Epson salts, and water.
